(19) United States
(12) Patent Application Publication
(10) Pub. No.: US 2014/0282354 A1
(43) Pub. Date: Sep. 18, 2014

(54) AUTOMATED TEAM ASSEMBLY SYSTEM AND METHOD

(71) Applicant: INTERNATIONAL BUSINESS MACHINES CORPORATION, Armonk, NY (US)

(72) Inventors: Lee Berry, Ashfield (AU); Philip S. P. Chan, Marrickville (AU); Praven Naidoo, Epping (AU)

(73) Assignee: International Business Machines Corporation, Armonk, NY (US)

(21) Appl. No.: 13/836,053

(22) Filed: Mar. 15, 2013

(51) Int. Cl. G06F 9/44

(52) U.S. Cl. CPC G06F 8/70
USPC 717/101

(57) ABSTRACT

A method, computer program product, and computer system for receiving, by a computing device, a query including criteria associated with a software development project. Information is analyzed based upon, at least in part, the criteria. One or more users that meet at least a portion of the criteria are determined. At least a portion of the one or more users is identified as recommended candidate team members for the software development project.

### BACKGROUND

Projects, such as software development projects, may be prone to failure. Example reasons why software development projects may fail include such things as a lack of technical tools available to the software development project team and incompatible team members being picked to form the team. While there may have been improvements in the technical tools that a team may use, picking the right team for the software development project and nurturing skill growth within the team continues to be a manual, intuition based process. The distributed nature of many modern software development projects (e.g., where teams and members may not always have direct knowledge of one another) may introduce increased risk to the project's success when selecting and assigning work to remote team members without an adequate understanding of, e.g., their skills.

### BRIEF SUMMARY OF DISCLOSURE

In one implementation, a method, performed by one or more computing devices, comprises receiving, by a computing device, a query including criteria associated with a software development project. Information is analyzed based upon, at least in part, the criteria. One or more users that meet at least a portion of the criteria are determined. At least a portion of the one or more users is identified as recommended candidate team members for the software development project.

One or more of the following features may be included. The information may include application lifecycle management information from previous software development projects. The application lifecycle management information may include customer issues associated with previous software development projects. The information may include evaluation information associated with the one or more users from previous software development projects. The criteria may include experience in an area associated with the software development project. The criteria may include availability of the one or more users to work on the software development project. The criteria may include previous interaction between two or more users of the one or more users.

In another implementation, a computing system includes a processor and a memory configured to perform operations comprising receiving a query including criteria associated with a software development project. Information is analyzed based upon, at least in part, the criteria. One or more users that meet at least a portion of the criteria are determined. At least a portion of the one or more users is identified as recommended candidate team members for the software development project.

One or more of the following features may be included. The information may include application lifecycle management information from previous software development projects. The application lifecycle management information may include customer issues associated with previous software development projects. The information may include evaluation information associated with the one or more users from previous software development projects. The criteria may include experience in an area associated with the software development project. The criteria may include availability of the one or more users to work on the software development project. The criteria may include previous interaction between two or more users of the one or more users.

In another implementation, a computer program product resides on a computer readable storage medium that has a plurality of instructions stored on it. When executed by a processor, the instructions cause the processor to perform operations comprising receiving a query including criteria associated with a software development project. Information is analyzed based upon, at least in part, the criteria. One or more users that meet at least a portion of the criteria are determined. At least a portion of the one or more users is identified as recommended candidate team members for the software development project.

One or more of the following features may be included. The information may include application lifecycle management information from previous software development projects. The application lifecycle management information may include customer issues associated with previous software development projects. The information may include evaluation information associated with the one or more users from previous software development projects. The criteria may include experience in an area associated with the software development project. The criteria may include availability of the one or more users to work on the software development project. The criteria may include previous interaction between two or more users of the one or more users.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is an illustrative diagrammatic view of a candidate ID process coupled to a distributed computing network according to one or more implementations of the present disclosure;

FIG. 2 is a diagrammatic view of a client electronic device of FIG. 1 according to one or more implementations of the present disclosure;

FIG. 3 is an illustrative flowchart of the candidate ID process of FIG. 1 according to one or more implementations of the present disclosure;

FIG. 4 is an illustrative diagrammatic view of a screen image displayed by the candidate ID process of FIG. 1 according to one or more implementations of the present disclosure;

FIG. 5 is an illustrative diagrammatic view of a screen image displayed by the candidate ID process of FIG. 1 according to one or more implementations of the present disclosure; and

FIG. 6 is an illustrative diagrammatic view of a screen image displayed by the candidate ID process of FIG. 1 according to one or more implementations of the present disclosure.

Like reference symbols in the various drawings indicate like elements.

### DETAILED DESCRIPTION

### System Overview

As will be appreciated by one skilled in the art, the present disclosure may be embodied as a method, system, or computer program product. Accordingly, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of this document, a computer-usable or computer-readable, storage medium may be any tangible medium that can contain or store a program for use by or in connection with the instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. The computer readable program code may be transmitted using any appropriate medium, including but not limited to the internet, wireline, optical fiber cable, RF, etc. A computer readable signal medium may be any computer readable medium that is not a computer readable storage medium and that can communicate, propagate, or transport a program for use by or in connection with an instruction execution system, apparatus, or device.

Computer program code for carrying out operations of the present disclosure may be written in an object oriented programming language such as Java®, Smalltalk, C++ or the like. Java and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript or PERL. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider).

The flowchart and block diagrams in the figures illustrate the architecture, functionality, and operation of possible implementations of apparatus (systems), methods and computer program products according to various implementations of the present disclosure. It will be understood that each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some alternative implementations, the functions noted in the block(s) may occur out of the order noted in the figures. For example, two blocks shown in succession may, in fact, be executed substantially concurrently, or the blocks may sometimes be executed in the reverse order, depending upon the functionality involved.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

The computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

Referring to FIG. 1, there is shown candidate ID process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a personal computer(s), a laptop computer(s), mobile computing device(s), a server computer, a series of server computers, a mainframe computer(s), or a computing cloud(s). Computer 12 may execute an operating system, for example, but not limited to, Microsoft® Windows®; Mac® OS X®; Red Hat® Linux®, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

As will be discussed below in greater detail, candidate ID process 10 may receive, by a computing device, a query (e.g., query 17) including criteria associated with a software development project. Information may be analyzed based upon, at least in part, the criteria. One or more users that meet at least a portion of the criteria may be determined. At least a portion of the one or more users may be identified as recommended candidate team members for the software development project.

The instruction sets and subroutines of candidate ID process 10, which may be stored on storage device 16 coupled to computer 12, may be executed by one or more processors (not shown) and one or more memory architectures (not shown) included within computer 12. Storage device 16 may include but is not limited to: a hard disk drive; a flash drive, a tape drive; an optical drive; a RAID array; a random access memory (RAM); and a read-only memory (ROM).

Network 14 may be connected to one or more secondary networks (e.g., network 18), examples of which may include but are not limited to: a local area network; a wide area network; or an intranet, for example.

Computer 12 may include a data store, such as a database (e.g., relational database, object-oriented database, triplestore database, etc.) and may be located within any suitable memory location, such as storage device 16 coupled to computer 12. Any data described throughout the present disclosure may be stored in the data store. In some implementations, computer 12 may utilize a database management system such as, but not limited to, IBM DB2, and “My Structured Query Language” (MySQL®) in order to provide multi-user access to one or more databases, such as the above noted relational database. The data store may also be a custom database, such as, for example, a flat file database or an XML database. Any other form(s) of a data storage structure and/or organization may also be used. Candidate ID process 10 may be a component of the data store, a stand alone application that interfaces with the above noted data store and/or an applet/application that is accessed via client applications 22, 24, 26, 28. The above noted data store may be, in whole or in part, distributed in a cloud computing topology. In this way, computer 12 and storage device 16 may refer to multiple devices, which may also be distributed throughout the network.

Computer 12 may execute a software development tools application (e.g., Application Lifecycle Management (ALM) application 20), examples of which may include, but are not limited to, e.g., a requirements management application, an architecture application, a coding application, a testing application, a tracking application, a release management application, or other application that allows for a process of managing the life of an application through such things as governance, development and maintenance. Candidate ID process 10 and/or ALM application 20 may be accessed via client applications 22, 24, 26, 28. Candidate ID process 10 may be a stand alone application, or may be an applet/application/script that may interact with and/or be executed within ALM application 20 and/or one or more of client applications 22, 24, 26, 28. ALM application 20 may be a stand alone application, or may be an applet/application/script that may interact with and/or be executed within candidate ID process 10 and/or one or more of client applications 22, 24, 26, 28. One or more of client applications 22, 24, 26, 28 may be a stand alone application, or may be an applet/application/script that may interact with and/or be executed within candidate ID process 10 and/or ALM application 20. Examples of client applications 22, 24, 26, 28 may include, but are not limited to, e.g., a requirements management application, an architecture application, a coding application, a testing application, a tracking application, a release management application, or other application that allows for a process of managing the life of an application through such things as governance, development and maintenance, a standard and/or mobile web browser, an email client application, a textual and/or a graphical user interface, a customized web browser, a plugin, or a custom application. The instruction sets and subroutines of client applications 22, 24, 26, 28, which may be stored on storage devices 30, 32, 34, 36 coupled to client electronic devices 38, 40, 42, 44, may be executed by one or more processors (not shown) and one or more memory architectures (not shown) incorporated into client electronic devices 38, 40, 42, 44.

Storage devices 30, 32, 34, 36 may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart phone (e.g., client electronic device 42), a notebook computer (e.g., client electronic device 44), a tablet (not shown), a server (not shown), a data-enabled, cellular telephone (not shown), a television (not shown), a smart television (not shown), a media (e.g., video, photo, etc.) capturing device (not shown), and a dedicated network device (not shown). Client electronic devices 38, 40, 42, 44 may each execute an operating system, examples of which may include but are not limited to, Android™, Apple® iOS®, Mac® OS X®; Red Hat® Linux®, or a custom operating system.

One or more of client applications 22, 24, 26, 28 may be configured to effectuate some or all of the functionality of candidate ID process 10 (and vice versa). Accordingly, candidate ID process 10 may be a purely server-side application, a purely client-side application, or a hybrid server-side/client-side application that is cooperatively executed by one or more of client applications 22, 24, 26, 28 and/or candidate ID process 10.

One or more of client applications 22, 24, 26, 28 may be configured to effectuate some or all of the functionality of ALM application 20 (and vice versa). Accordingly, ALM application 20 may be a purely server-side application, a purely client-side application, or a hybrid server-side/client-side application that is cooperatively executed by one or more of client applications 22, 24, 26, 28 and/or ALM application 20. As one or more of client applications 22, 24, 26, 28, candidate ID process 10, and ALM application 20, taken singly or in any combination, may effectuate some or all of the same functionality, any description of effectuating such functionality via one or more of client applications 22, 24, 26, 28, candidate ID process 10, ALM application 20, or combination thereof, and any described interaction(s) between one or more of client applications 22, 24, 26, 28, candidate ID process 10, ALM application 20, or combination thereof to effectuate such functionality, should be taken as an example only and not to limit the scope of the disclosure.

Users 46, 48, 50, 52 may access computer 12 and candidate ID process 10 (e.g., using one or more of client electronic devices 38, 40, 42, 44) directly through network 14 or through secondary network 18. Further, computer 12 may be connected to network 14 through secondary network 18, as illustrated with phantom link line 54. Candidate ID process 10 may include one or more user interfaces, such as browsers and textual or graphical user interfaces, through which users 46, 48, 50, 52 may access candidate ID process 10.

The various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, Wi-Fi, and/or Bluetooth™ device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown directly coupled to network 14.

Some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ is a telecommunications industry specification that allows, e.g., mobile phones, computers, smart phones, and other electronic devices to be interconnected using a short-range wireless connection.

Referring also to FIG. 2, there is shown a diagrammatic view of client electronic device 38. While client electronic device 38 is shown in this figure, this is for illustrative purposes only and is not intended to be a limitation of this disclosure, as other configurations are possible. For example, any computing device capable of executing, in whole or in part, candidate ID process 10 may be substituted for client electronic device 38 within FIG. 2, examples of which may include but are not limited to computer 12 and/or client electronic devices 40, 42, 44.

Client electronic device 38 may include a processor and/or microprocessor (e.g., microprocessor 200) configured to, e.g., process data and execute the above-noted code/instruction sets and subroutines. Microprocessor 200 may be coupled via a storage adaptor (not shown) to the above-noted storage device. An I/O controller (e.g., I/O controller 202) may be configured to couple microprocessor 200 with various devices, such as keyboard 206, pointing/selecting device (e.g., mouse 208), custom device (e.g., device 215), USB ports (not shown), and printer ports (not shown). A display adaptor (e.g., display adaptor 210) may be configured to couple display 212 (e.g., CRT or LCD monitor(s)) with microprocessor 200, while network controller/adaptor 214 (e.g., an Ethernet adaptor) may be configured to couple microprocessor 200 to the above-noted network 14 (e.g., the Internet or a local area network).

The Candidate ID Process:

As discussed above and referring also to FIGS. 3-6, candidate ID process 10 may receive 300, by a computing device, a query including criteria associated with a software development project. Information may be analyzed 302 by candidate ID process 10 based upon, at least in part, the criteria. Candidate ID process 10 may determine 304 that one or more users meet at least a portion of the criteria. At least a portion of the one or more users may be identified 306 by candidate process 10 as recommended candidate team members for the software development project.

Selecting the best teams or their member(s) for a project (e.g., a software development project) may be difficult for any number of reasons. For example, the distributed nature of many modern software development projects (e.g., where teams may not always have direct knowledge of one another) may increase the risk to the project's success when selecting and assigning work to remote team members without an adequate understanding of, e.g., their skills Such an understanding of their skills may come from many sources. For example, software development teams may use development tools that may provide, among other things, a consolidated view of software development projects (past and present) under the banner “Application Lifecycle Management” (ALM). Generally, ALM (as well as similar development tools) may be described as a continuous process of managing the life of an application through governance, development and maintenance. ALM may further be described as the marriage of business management to software engineering made possible using example tools that may facilitate and integrate requirements management, architecture, coding, testing, tracking, release management, etc. An example of an ALM tool may include but is not limited to ALM application 20.

For instance, ALM application 20 may include tools, such Rational Collaborative Lifecycle Management, which may be capable of capturing data across the entire life span of a project. For example, the captured data in the context of a software development project may include activities such as but not limited to: the creation of, or change to, a requirement; creation and modification of design and architectural artifacts; work items; code changes based on new features, refactoring, and defect fixes; the discovery of code defects; deployment of software into test and production environments; discovery of defects in production; team member allocation; daily reports and metrics; process changes; plans, etc. The record of one or more of these example activities (e.g., which may be stored in the above-noted data store or elsewhere) may include such things as but not limited to the individuals that initiated and/or performed the action, when the action took place, how long it took, and relative and/or absolute defect rate. Candidate process 10 may, in some implementations, use the above-noted information (e.g., data, records, etc.) collected by, e.g., ALM application and/or candidate ID process 10, from past projects to provide guidance on the composition of a team for a particular project (e.g., based on criteria specific to that project). This may, in some implementations, enable, e.g., managers and/or team leaders to make informed decisions when assembling a team that satisfies a project's and a team member's developmental requirements based on, e.g., quantitative data. Such decisions may be scaled to large teams and projects.

In some implementations, candidate ID process 10 may receive 300, by a computing device (e.g., computer 12), a query (e.g., query 17) including criteria associated with a software development project. For instance, assume for example purposes only that a user (e.g., user 46) is a team manager attempting to put together a team for a software development project. User 46 may (e.g., via user interface 400 of client application 22, candidate ID process 10 and/or ALM application 20) enter the criteria to be used in query 17. For example, and referring at least to FIG. 4, example user interface 400 may include an object (e.g., window 402) that may include one or more fields where user 46 may use a pointing device, e.g., mouse 208 and associated curser 404, to select, enter, or otherwise denote the desired criteria.

For example, the criteria may include experience in an area associated with the software development project. For instance, assume for example purposes only that user 46 is assembling a software development team to develop software in the area of “Product Area A”. In the example, user 46 may select field 406 (e.g., Experience Area/Level field), where user 46 may manually enter “Product Area A”. In some implementations, selecting field 406 may result in a drop down menu where user 46 may select “Product Area A” from one or more other product area options. Other techniques of selecting, entering, or otherwise denoting the desired experience criteria may be used without departing from the scope of the disclosure. In some implementations, the experience may include the level of expertise in a particular area (e.g., expert level, mid-level, junior level, etc.). Other experience examples (and rating scales) may be used without departing from the scope of the disclosure. For instance, the level of expertise may be denoted in terms of years of experience, or on a scale of 1 to 10, where 1 is the most junior level and 10 is the most expert level, etc.

As another example, the criteria may include availability of the one or more users to work on the software development project. For instance, assume for example purposes only that user 46 is assembling a software development team to develop software that is scheduled to be released in a short period of time (e.g., 2 months), such that the project should be started as soon as possible. In the example, user 46 may select field 408 (e.g., Availability field), where user 46 may manually enter, e.g., “As Soon As Possible”, “Immediately”, etc. In some implementations, selecting field 406 may result in a drop down calendar menu where user 46 may select one or more dates, or a range of dates showing desired availability. In some implementations, candidate ID process 10 may include a scheduling process, which may have access to calendaring information of the pool of candidates for the project team. Other techniques of selecting, entering, or otherwise denoting the desired availability criteria may be used without departing from the scope of the disclosure.

As another example, the criteria may include previous interaction between two or more users of the one or more users. For instance, assume for example purposes only that user 46 believes that the best team involves team members that have worked together in the past. In the example, user 46 may select field 410 (e.g., Interaction field), where user 46 may manually enter the names of one or more software developers. In some implementations, selecting field 406 may result in a drop down menu where user 46 may select one or more software developers. In some implementations, field 410 may include an object (e.g., box icon) (not shown) that may be checked. In some implementations, field 410 may include an option to enter the minimum number of times team members have worked together in the past. Other techniques of selecting, entering, or otherwise denoting the desired interaction criteria may be used without departing from the scope of the disclosure. In some implementations, the above-noted criteria of previous interaction need not be limited to being between previous team members that have previously interacted. For example, the belief of user 46 that the best team involves team members that have worked together in the past may be extrapolated to include possible team members (that have not previously worked/interacted together) as recommended using, e.g., “social recommendations” techniques. As a non-limiting example of a social recommendation technique, assume that user A liked working with user C (and vice versa), and user B liked working with user C (and vice versa). Therefore, in the example, candidate ID process 10 may determine that user A may like working with user B (and vice versa). As will be discussed further below, information about the above-noted previous interactions may be provided by, e.g., peer reviews, which may be stored in the above-noted data store. While example criteria are discussed above, it will be appreciated that other example criteria may be used without departing from the scope of the disclosure. For example, the quality of the software developer's work product (e.g., great, good, average, poor, etc.) may be used. For instance, a project may be of low priority and user 46 may not want to use valuable resources (e.g., an expert developer with consistently great work products) on the project in case such resources are needed on a more urgent project. In the example, a candidate team member with less than great work products may be more desirable.

Other example criteria may include, e.g., an estimated duration of a project, urgency of a project, team member role(s) to be filled (e.g., team leader, mentor, junior developer, etc.), inter-personal user ratings, etc. For example, in some implementations, the above-noted criteria may be applied to help user 46 make developmental decisions on how to structure a team. For instance, user 46 may want to form a remote team for a small project that provides user 48 (an emerging team leader) with a more experienced engineer to coach user 48, as well as more junior engineers for user 48 to coach. In the developmental example, user 46 may select criteria to ensure that there is an existing relationship between team members (which may be indicated via the above-described interaction field 410), particularly the team leader and the senior developer, which may need to be one of mutual respect. Additionally/alternatively, criteria may similarly be used to find projects rather than or in addition to team members for the project. For example, user 46 may select criteria indicating that the project is a non-critical project to give the team leader time to develop their skills in a less stressful environment. As such, the above example criteria, as well as using the criteria for finding team members for a project (and vice versa), should be taken as an example only and not to otherwise limit the scope of the disclosure.

In some implementations, information may be analyzed 302 by candidate ID process 10 based upon, at least in part, the criteria. Each criterion may effectively define a function that may be run against the pool of potential candidate team members (e.g., that may be accessed in the above-noted data store) with the goal of producing a list of candidate teams, or individual candidates for each position in a team. For example, as will be discussed in greater detail below, candidate ID process 10 may analyze (e.g., compare) the criteria in query 17 with the information stored by example in the above-noted data store. In some implementations, user 46 may define query 17 (via candidate ID process 10) as noted above that may be run by candidate ID process 10 against the above-noted data store, which may be a batch processed view of the “live” ALM data associated with the (past and present) software development projects.

In some implementations, the information may include application lifecycle management information from previous software development projects. For example, the above-noted ALM data captured across the entire life span of one or more projects may include but is not limited to the creation of, or change to, a requirement; creation and modification of design and architectural artifacts; code changes based on new features, refactoring, and defect fixes; the discovery of code defects; deployment of software into test and production environments; discovery of defects in production; team member allocation; process changes, as well as the individuals that initiated and/or performed the action, when the action took place, and how long it took, which may be stored (e.g., in the above-noted data store) for analysis 302.

In some implementations, the application lifecycle management information may include customer issues associated with previous software development projects. For example, after a software project is finished and released to the public, the customers may find problems or “bugs” with the software and report those bugs to the software developer's company. The number of reports, as well as the details of each report (e.g., type of bug) may be stored (e.g., in the above-noted data store) for analysis 302.

In some implementations, the information may include evaluation information associated with the one or more users from previous software development projects. For example, in addition to gathering information (e.g., numerical information) on specific project deliverables and artifacts, candidate ID process 10 (and/or ALM application 20) may gather and store (e.g., in the above-noted data store) subjective data on how individual users (e.g., team members) interacted and behaved during one or more projects. For example, the information may be similar to yearly (or project specific) performance reviews, and may include evaluations (e.g., from the perspective of respective team mates) reporting on the performance and impact of themselves as well as their respective team mates. For example, a peer evaluation may include information regarding a team members' ability to, e.g., coach others; take direction; build consensus within the team; overcome setbacks and successfully execute a project; exert a positive influence over the team; adapt to changing project conditions, etc., and may be stored (e.g., in the above-noted data store) for analysis 302. Additionally, peer evaluation information may include an indication of whether individuals respect one another (e.g., professionally and/or personally), have engaged in productive working relationships, etc. Other examples of information (such as the above-noted scheduling information) may be included in the above-noted data store for analysis without departing from the scope of the disclosure. In some implementations, candidate ID process 10 may enable user 46 to define his/her own criteria (e.g., via user interface 400). As such, the information described throughout should be taken as an example only and not to otherwise limit the scope of the disclosure.

As noted above, the above-noted information may be analyzed 302 by candidate ID process 10 based upon, at least in part, the criteria. Candidate process 10 may include analytical abilities similar to those used by, e.g., IBM's Rational Insight or the like. In some implementations, candidate process 10 may determine 304 that one or more users meet at least a portion of the criteria. For instance, assume for example purposes only that user 46 has issued example query 17 that is received 300 by candidate ID process 10, where query 17 includes an expert experience level in the area of “Product Area A” (as indicated in field 406), an immediate availability (as indicated in field 408), and has interacted with, e.g., user 52 on at least one project (as indicated in field 410). In the example, candidate ID process 10 may analyze 302 the above-noted information (stored by example in the above-noted data store) and determine 304 that one or more software developers either are an expert in “Product Area A”, are immediately available, and/or have interacted with, e.g., user 52 on at least one project.

In some implementations, at least a portion of the one or more users may be identified 306 as recommended candidate team members for the software development project. For instance, continuing with the above example where candidate ID process 10 has determined 304 that one or more software developers meet at least a portion of the criteria in query 17, candidate ID process 10 may identify 306 and recommend those software developers to user 46 as possible team members for the software development project. In some implementations, candidate ID process 10 may provide the identified 306 candidates to user 46 as a list, which may be displayed (e.g., via client application 22 at client electronic device 38). For example, and referring at least to FIG. 5, a list (e.g., list 500) is shown. List 500 may include an avatar 502 (or other visual object representing a particular user/developer). List 500 may be ordered by candidate ID process 10 according to which users match the most criteria from query 17. For example, a user that matches all criteria from query 17 may be first on list 500, where a user that matches two out of three criteria from query 17 may be second on list 500, and where a user that matches one out of three criteria from query 17 may be third on list 500, etc. List 500 may be ordered in alternative ways (e.g., reverse order) without departing from the scope of the disclosure.

In some implementations, at each decision point (e.g., when individual criteria are determined to have been met), candidate ID process 10 may recommend or not recommend an individual user to user 46 (e.g., on the fly). In some implementations, candidate ID process 10 may wait until all users have been evaluated against each criteria before returning recommendations to user 46.

In some implementations, candidate ID process 10 may filter out those in the candidate pool of potential team members that do not meet some or all of the criteria in query 17. In some implementations, candidate ID process 10 may use a “best match” technique to identify 306 and recommend those software developers to user 46 as possible team members for the software development project, even if none of those in the candidate pool of potential team members meet any of the criteria in query 17. For instance, assume for example purposes only that that query 17 only includes an expert level indicated in field 406. In the example, candidate ID process 10 may still identify 306 and recommend user 50 as a possible team member for the software development project if user 50 has a threshold (e.g., minimum) expertise level (e.g., 5 years experience where 8 years of experience may be considered an expert). In some implementations, candidate ID process 10 may provide the “best match” list of candidates to user 46 explaining that user 50 (and/or other users) do not literally meet any criteria from query 17 but that user 50 is the best candidate out of the remaining candidate pool. For example, and referring at least to FIG. 6, a list (e.g., list 600) is shown. List 600 may include an avatar 602 of user 50 with explanation 604 explaining the deficiencies of user 50 from the criteria of query 17. Explanation 604 may also be applied to those listed in list 500 without departing from the scope of the disclosure. As such, user 46 may still consider the list of non-recommended engineers and either apply a more sophisticated selection criteria or by manually examining the list to make the appropriate selection.

While the present disclosure is described using ALM application 20, it will be appreciated that other tools from other vendors or bespoke solutions may be used without departing from the scope of the disclosure. As such, the use of ALM application 20 (and the associated tools) should be taken as an example only and not to limit the scope of the disclosure.

Additionally, while the present disclosure is described using software development projects, it will be appreciated that other types of projects may be used without departing from the scope of the disclosure. As such, the use of a software development project should be taken as an example only and not to limit the scope of the disclosure.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, and any combinations thereof will be apparent to those of ordinary skill in the art without departing from the scope and spirit of the disclosure. The implementation(s) were chosen and described in order to best explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, and combinations thereof) are possible without departing from the scope of the disclosure defined in the appended claims.

What is claimed is:

1. A computer-implemented method comprising:
receiving, by a computing device, a query including criteria associated with a software development project;
analyzing information based upon, at least in part, the criteria;
determining one or more users that meet at least a portion of the criteria; and
identifying at least a portion of the one or more users as recommended candidate team members for the software development project.

2. The computer-implemented method of claim 1 wherein the information includes application lifecycle management information from previous software development projects.

3. The computer-implemented method of claim 2 wherein the application lifecycle management information includes customer issues associated with previous software development projects.

4. The computer-implemented method of claim 1 wherein the information includes evaluation information associated with the one or more users from previous software development projects.

5. The computer-implemented method of claim 1 wherein the criteria includes experience in an area associated with the software development project.

6. The computer-implemented method of claim 1 wherein the criteria includes availability of the one or more users to work on the software development project.

7. The computer-implemented method of claim 1 wherein the criteria includes previous interaction between two or more users of the one or more users.

8. A computing system including a processor and a memory configured to perform operations comprising:
receiving a query including criteria associated with a software development project;
analyzing information based upon, at least in part, the criteria;
determining one or more users that meet at least a portion of the criteria; and
identifying at least a portion of the one or more users as recommended candidate team members for the software development project.

9. The computing system of claim 8 wherein the information includes application lifecycle management information from previous software development projects.

10. The computing system of claim 9 wherein the application lifecycle management information includes customer issues associated with previous software development projects.

11. The computing system of claim 8 wherein the information includes evaluation information associated with the one or more users from previous software development projects.

12. The computing system of claim 8 wherein the criteria includes experience in an area associated with the software development project.

13. The computing system of claim 8 wherein the criteria includes availability of the one or more users to work on the software development project.

14. The computing system of claim 8 wherein the criteria includes previous interaction between two or more users of the one or more users.

15. A computer program product residing on a computer readable storage medium having a plurality of instructions stored thereon which, when executed by a processor, cause the processor to perform operations comprising:
receiving a query including criteria associated with a software development project;
analyzing information based upon, at least in part, the criteria;
determining one or more users that meet at least a portion of the criteria; and
identifying at least a portion of the one or more users as recommended candidate team members for the software development project.

16. The computer program product of claim 15 wherein the information includes application lifecycle management information from previous software development projects.

17. The computer program product of claim 16 wherein the application lifecycle management information includes customer issues associated with previous software development projects.

18. The computer program product of claim 15 wherein the information includes evaluation information associated with the one or more users from previous software development projects.

19. The computer program product of claim 15 wherein the criteria includes experience in an area associated with the software development project.

20. The computer program product of claim 15 wherein the criteria includes availability of the one or more users to work on the software development project.

21. The computer program product of claim 15 wherein the criteria includes previous interaction between two or more users of the one or more users.
